(19) United States
(12) Patent Application Publication
(10) Pub. No.: US 2017/0049205 A1
(43) Pub. Date: Feb. 23, 2017

(54) EXTERNAL LIGHTING FOR BAG IDENTIFICATION

(71) Applicant: Pamela Tekin, Laguna Beach, CA (US)

(72) Inventor: Pamela Tekin, Laguna Beach, CA (US)

(21) Appl. No.: 15/233,422

(22) Filed: Aug. 10, 2016

Related U.S. Application Data
(60) Provisional application No. 62/206,137, filed on Aug. 17, 2015.

(51) Int. Cl. A45C 15/06; F21V 33/00

(52) U.S. Cl. CPC A45C 15/06; F21V 33/0004; F21W 2121/00

(57) ABSTRACT

A personal item container, such as a purse, hand bag, tote, luggage provided with identification means capable of being illuminated.

### RELATED APPLICATION

This application claims the benefit under 35 U.S.C. §119 to U.S. Provisional Application Ser. No. 62/206,137, filed Aug. 17, 2015, which is incorporated by reference herein.

### BACKGROUND

Field

The present disclosure is related to illumination of an object which can be viewed on the outside of a personal item container (“PIC”) such as a hand-held bag or hand bag, purse, pocketbook, clutch, tote bag, all-purpose carrying bag, luggage, briefcase, duffel bag, laptop bag, satchel, diaper bag, gym bag, travel bag and the like.

Description of the Related Art

Existing personal item containers (“PICs”) include interior lighting arrangements so that when a container is opened, the gentleman or lady can see the contents in his or her bag and can easily find a door key, wallet, or the like, therein.

The present disclosure is directed toward personal item containers (“PICs”) that can include a non-opaque object, such as a precious stone (e.g., sapphire, ruby, diamond, etc.) or a non-precious material such as colored glass, on an exterior surface of the PIC. Such an object can be useful in identifying the PIC of an owner. Furthermore, in the case of precious stones, it can be difficult to appreciate the beauty of the precious stone without proper illumination. Thus, the need exists for a PIC which is configured to illuminate the object such that the illuminated object can be observed from the exterior of the PIC.

Certain aspects of the disclosure are also directed toward PICs that can include a jewelry box feature, such as a compartment slidably inserted into the body of the PIC. While jewelry can be haphazardly placed inside any PIC, the jewelry can be difficult to locate once inside the PIC due to the PIC's typically small and cluttered interior space. Thus, the need exists for a PIC which is partially configured to act as a jewelry box such that jewelry and the like can be isolated from other personal items within the PIC for easy discovery.

Certain aspects of the disclosure are directed toward an illuminated PIC including an electrical apparatus configured to illuminate an object capable of being viewed on the outside of the bag. For example, an illuminated PIC can be configured to illuminate a non-opaque object by utilizing a light source inside the PIC, behind the non-opaque object, so that the light transmitted through the object can be observed on the outside of the PIC. The illuminated PIC can include a body having an opaque wall portion defining an interior space and an opening at an upper portion of the body through which the interior space can be accessed, the opaque wall portion including an aperture, a non-opaque member at least partially exterior to the aperture in the exterior surface of the wall portion, and a light source positioned in the interior space and radially inward of the non-opaque member and configured to project light outward and through the non-opaque member, such that the light source illuminates the non-opaque member when the light source is illuminated.

Certain aspects of the disclosure are directed to an illuminated PIC including a compartment inserted within the body of the PIC. The compartment, which can be configured to hold personal items such as jewelry, can be accessed by removing at least a portion of the compartment from the body of the PIC. The compartment can also be configured into a position where the contents of the compartment are not accessible. In some instances, a flap portion can be attached to the body of the PIC and can conceal the compartment when the contents of the compartment are not accessible.

Any feature, structure, or step disclosed herein can be replaced with or combined with any other feature, structure, or step disclosed herein, or omitted. Further, for purposes of summarizing the disclosure, certain aspects, advantages, and features of the inventions have been described herein. It is to be understood that not necessarily any or all such advantages are achieved in accordance with any particular embodiment of the inventions disclosed herein. No individual aspects of this disclosure are essential or indispensable.

### BRIEF DESCRIPTION OF THE DRAWINGS

FIG. 1 illustrates a front perspective view of an illuminated PIC.

FIG. 2 illustrates a front perspective view of another illuminated PIC.

FIG. 3 illustrates an interior view of yet another illuminated PIC.

FIGS. 4A through 4D illustrate an illuminated object mounted to a mounting member.

FIG. 5 illustrates a cross section of an illuminated PIC.

FIG. 6 illustrates yet another illuminated PIC.

FIG. 7 illustrates the illuminated PIC shown in FIG. 6 with the flap portion released.

FIG. 8 illustrates the illuminated PIC shown in FIG. 6 with the compartment slid outward.

Various embodiments are depicted in the accompanying drawings for illustrative purposes, and should in no way be interpreted as limiting the scope of the embodiments. Furthermore, various features of different disclosed embodiments can be combined to form additional embodiments, which are part of this disclosure.

### DETAILED DESCRIPTION

The present disclosure relates generally to illumination of a non-opaque member by placing a light source inside a personal item container (“PIC”), behind the non-opaque member, such that light is transmitted through the optically transmissive material the illuminated non-opaque object can be observed on the outside of the PIC. A non-opaque member may be described herein as an object that is optically transmissive. Such objects can be illuminated by transmitting light through the object. The object may have features that reflect or scatter light and/or alter the color of the light passed through the object. Such light may be detected by the eye of an observer causing the observer to discern the illuminated object and/or light transmitted therethrough.

A PIC is defined to be any portable container suitable for carrying personal items such as money, make-up, jewelry, clothing, sporting equipment, office supplies, cellular phones, portable media players, toiletries, diapers, baby products and the like. Thus, a PIC can refer to, among other things, hand bags, purses, pocketbooks, clutches, tote bags, all-purpose carrying bags, luggage, briefcases, duffel bags, laptop bags, satchels, diaper bags, gym bags, and travel bags.

A PIC can be made of any material or combination of materials capable of carrying the aforementioned personal items. These materials can be natural such as silk, cotton or wool, or synthetic such as nylon, polyethylene, or aramid. Other acceptable materials can include leather, faux leather, fabric, fur, animal, reptile or bird skin, plastic, metal, vinyl, rayon, polyester, latex, suede, and the like. Generally, the body of the PIC can be made of opaque materials. However, in some instances, at least a portion of the PIC can be non-opaque, i.e., transparent or translucent.

A PIC can include a single layer of material or multiple layers of material. Each layer can be made of a single material or a combination of materials. In some instances, the PIC can include an outer layer and at least one inner layer. The outer layer can be more durable than an inner layer in. For instance, the outer layer can be scratch resistant or water resistant in order to protect the external appearance of the PIC. Further, the outer layer can be made of more expensive materials than the inner layer or layers. In some instances, the outer layer of a PIC can be made of leather while the internal layer can be made of fabric, such as cotton or polyester.

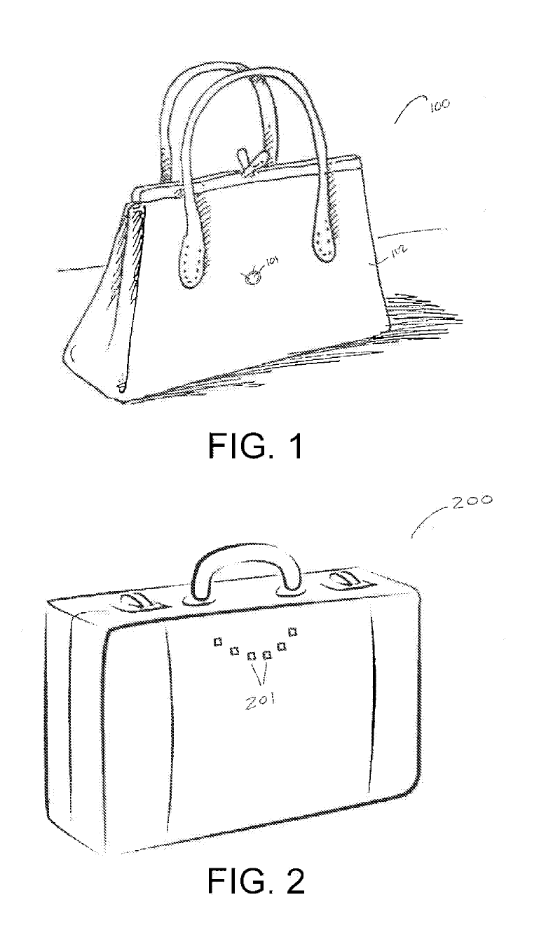

FIG. 1 illustrates a front perspective view of an illuminated PIC.

Referring to FIG. 1, the illuminated PIC 100 can include an object 101 attached to a wall 102 of the PIC 100 wherein at least a portion of the object 101 can be seen on the exterior of the PIC 100. In some instances, the illuminated object 101 can identify and distinguish the goods or services of one party from others. Thus, illumination can be used as to create a distinguishing mark or feature for identifying and marketing a PIC 100.

The object 101 can be at least partially non-opaque, and therefore at least some light can pass through the object 101. The degree to which light is obscured by an object 101 can vary across embodiments. For instance, an object 101 can be translucent or transparent. Additionally, an object 101 might not uniformly allow light to pass through. Instead, an object 101 can be partially opaque, transparent or translucent. Moreover, light may be scattered or reflected off of features of the object. For example, light may reflect or scatter off edges where facets meet and cause the edge to be observable to a viewer. The illuminated object 101 may also appear to glow or radiate in contrast to the darker surrounding fabric, leather, or other materials forming the bag. If the object is colored, colored light may appear to radiate from the object. The object may, for example, filter or change the color of the light or be illuminated with colored light. Features within the object, such as edges between facets, which for example reflect, deflect, or scatter the light may be discernable.

Although FIG. 1 shows a single illuminated object 101, in some instances a PIC 100 can include more than one object 101. Typically, an object 101 can be located on a front facing surface of the PIC 100, as shown in FIG. 1. However, an object 101 can be located on any portion of the PIC 100, including but not limited to an exterior wall, the bottom, the top, or a handle of the PIC 100.

Additionally, the object 101 need not be centered in its location on the PIC 100. For instance, the object 101 can be positioned in corner, on an edge, or positioned at any other location or in any other manner.

The dimensions or size of an object 101 may vary in alternate examples. Typically, object size is based upon an object's maximum dimension. This could be measured as a maximum diameter for rounded objects, or, a maximum length for angular and faceted objects. The other dimensions of the objects will vary significantly based upon their shape. In some instances an object 101 can be less than 5/16 inch, 5/16 inch to 5/8 inch, ½ inch to ¾ inch, ¾ inch to 1 inch, ⅞ inch to 1⅜ inch, or greater than 1¼ inch. In instances where multiple objects are present, each of the multiple objects can be similar in size or the sizes can vary.

The shape of an object 101 may vary in alternate examples as an object can have any external form or appearance. An object can substantially be in the shape of a circle, triangle, square, trapezoid, rectangle, star, flower and the like or an object can have no specific shape. For instance, FIG. 1 depicts a circular object 101 while FIG. 2 depicts a square-shaped object 201. In instances where multiple objects are present, each object can have a different shape.

The color of an object 101 may vary in alternate examples. In some instances, an object 101 can be clear or colorless. In other instances, an object 101 can have a defined color or colors. Additionally, an object 101 can appear to have multiple colors depending on a viewing angle. In instances where multiple objects are present, the color of each object can be different from the color of the other objects present.

An object 101 can include one or more of a variety of materials, including but not limited to plastic, glass, and stone. In some instances an object 101 can include precious stone or semi-precious stone. For instance, an object 101 can include sapphire or ruby or other precious stone. Preferably, when the object is a precious or semi-precious stone, it will be a shaving or sliver of such stone. Additionally, an object 101 can be a glass of different colors that comprise a color filter and produce colored light when illuminated with white light. In some instances, an object 101 can include a combination of materials.

FIG. 2 illustrates a front view of an illuminated PIC 200. In embodiments such as FIG. 2, the PIC 200 can be a type of luggage 200 or any other type of PIC. Further, a PIC can include multiple illuminated objects 201 which can be arranged in any desired pattern or configuration, e.g., vertical, horizontal, curved, circular, square, rectangular, etc. When multiple objects 201 are used, the objects may be illuminated simultaneously, sequentially or in any other desired order of illumination.

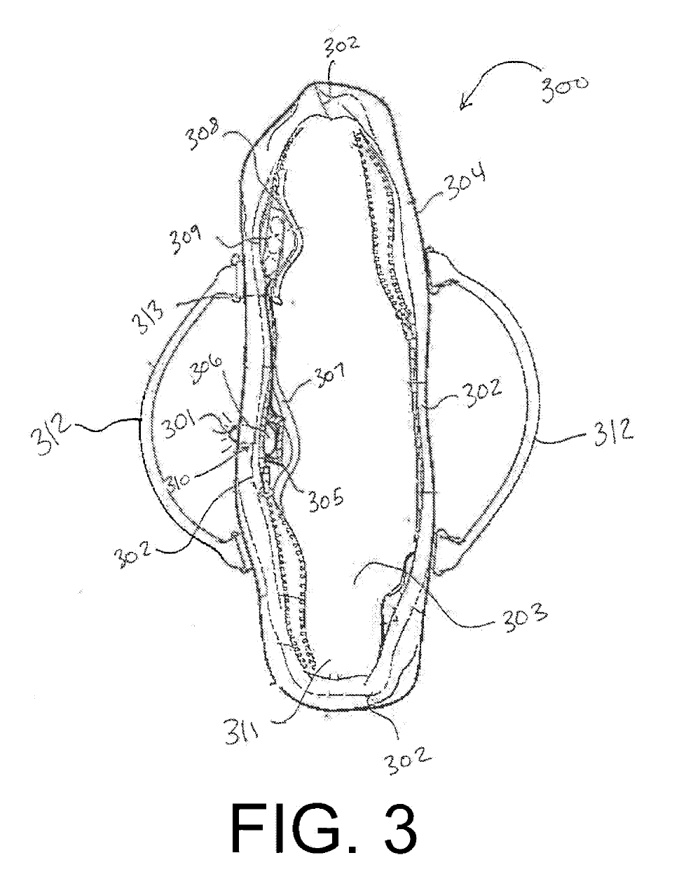

FIG. 3 illustrates an interior view of an illuminated PIC 300.

Referring to FIG. 3, the illuminated PIC 300 can include a wall portion 302 of a PIC 300 which defines an interior space 303 and an opening 311, a lighting system 306, 309, 313, an object 301, a mounting member 305, and a pocket 307, 308. Although FIG. 3 shows a single light source 306, some embodiments can include multiple light sources.

The PIC 300 can include a body 304 wherein the body 304 of the PIC 300 can include a wall portion 302 defining an interior space 303. The wall portion 302 further defines an opening 311 at an upper portion of the body 304 wherein the interior space 303 of the PIC 300 can be accessed. In some instances, the opening 311 defined by the wall portion 302 of the PIC 300 can be closable. For instance, the upper portion of the body 304 can include closures, such as zippers, buttons, magnets, clasps, snaps, and other fasteners and the like. As shown in FIG. 3, the PIC 300 can include one or more handles 312 attached to the upper portion of the body 304.

A lighting system can include a light source 306, a battery pack 309, connecting wires 313, a switch, a dimmer, a circuit board, a power plug connector, and the like. In a preferred embodiment, the lighting system can include an electrical apparatus wherein power can be provided to a light source 306.

In some instances, a light source 306 can receive power from one or more batteries 309. A battery 309 can be internal to the light source 306 or can be externally connected to the light source 306, for example, though connecting wires 313. In some instances, a light source 306 receives power from both an internal and external battery. In some instances, a battery 309 will be relatively small and long lasting so as to require little maintenance.

An internal or external battery 309 can be removable or permanent, and likewise can be rechargeable or non-rechargeable. In some instances, battery removal requires removing the light source 306 from the PIC 300. In other instances, a battery 309 removal can occur without removing the light source 306 from the PIC 300. Similarly, in some instances, a rechargeable battery 309 can be charged without removing the light source 306 from the PIC 300. For example, a battery 309 can be charged inductively (“wireless charging”) or a battery 309 can be charged utilizing an attachable power cord. In some instances, a power cord can be directly inserted into or connected to the light source 306 or external battery 309. In other instances, a power cord can be removably connected to a power connector, for example, threaded through a wall or lining of the PIC 300.

In some instances, a power switch, dimmer, or circuit hoard can be utilized to control a light source 306. For example, a switch can be configured to toggle the light source 306 between an on and off condition. A dimmer can be configured to control and adjust the brightness of a light source 306. A circuit board can be configured to perform as a switch or dimmer, or a circuit board can be utilized to dynamically control the light source 306. For instance, the circuit board could be configured to flash the light source 306 at a specific speed, periodically adjust the brightness, set a sleep timer to put the light source 306 to sleep, or the like.

While a variety of switches or dimmers can be used, it can be preferable to have a switch or dimmer which can be pressure triggered. For instance, it can be preferable to have a switch that can be easily activated with the finger and thumb of one hand.

A switch or dimmer can be located anywhere on the inside or outside of the PIC 300. However, it can be preferable to position the switch or dimmer inside the top of the PIC 300. Alternatively, the light source may be activated and deactivated by a remote controller, e.g., of the type used to open and close the door locks on automobiles.

The type of light source 306 may vary in alternate examples. Any light source 306 capable of projecting light through a non-opaque object 301 can be sufficient. Thus, any portable light source 306 known by one of skill in the art is acceptable. For example, a light source 306 can include an optical fiber or small or miniature light bulbs. In some instances a battery 309 will be relatively small. Therefore, a low power light source 306 will be preferred, such as an LED.

A light source 306 can project one or more colors or a mixture of colors. In examples with more than one light source 306, the color projected by a particular light source 306 can be independent of the colors projected by other light sources 306. In some instances, the light source 306 projects a bright light. In other instances, the light source 306 projects a dim light. In some instances, the light source 306 can be configured to allow adjustment of brightness level.

In some instances, when the light source 306 is illuminated, the projected light is not visible in the interior space 303 of the body 304 of the PIC 300. In other instances, the projected light is visible on the exterior and partially visible in the interior of the PIC 300.

The attachment of an object 301 to a PIC 300 may vary in alternate examples. An object 301 can be directly attached to the PIC 300 or an object 301 can be attached to a mounting member 305 and the mounting member 305 can be attached to the PIC 300.

An object 301, either directly attached or attached via a mounting member 305, can be permanently or removably secured to a PIC 300. For instance, an object 301 or mounting member 305 can be sewed to the interior of the body 304 of the PIC 300, attached with an adhesive, or permanently attached in a manner that would involve destruction of a portion of the product (e.g., bag) to detach the object from the PIC. In addition, an object 301 or mounting member 305 can be secured to the inner surface with hook and loop fasteners, snap fasteners, safety pins, hooks, prongs or other removable attachment method. In some instances, an object 301 can be mounted in a four-prong or six-prong setting. Pin connectors like electrical connector pins may be used. In other instances, the object 301 can be mounted with a plurality of projections configured to extend through at least a partial thickness of the wall portion. Each of the projections can include an end portion configured to bend relative to a remaining portion of each projection, such that the projections can engage the wall portion.

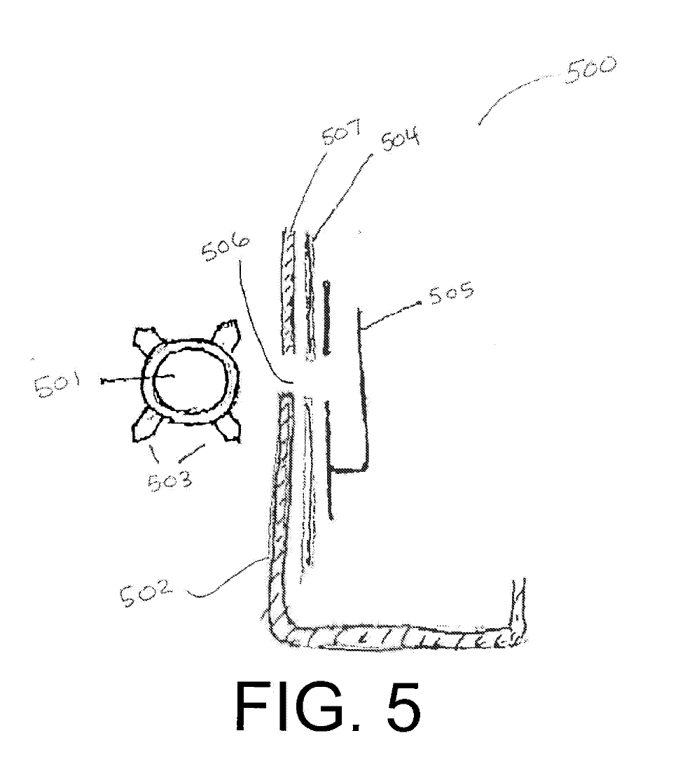

In some instances, a wall of the PIC 300 can include an aperture 310. See e.g., aperture 506 in the schematic cross-section shown in FIG. 5. The aperture 310 may vary in size in alternate examples. In some instances, the aperture 310 can be larger than the object 301 to ensure the light source 306 is aligned with the object 301. However, in some instances, the aperture 310 can be the same size as the object 301 or smaller than the object 301.

As depicted in FIG. 3, an object 301 can be attached to the PIC 300 after being positioned through or at the opening of an aperture 310 and then secured. An object 301 can be mounted partially exterior to the aperture 310, completely exterior to the aperture 310 or completely interior to the aperture 310. However mounted, at least a portion of the object 301 can be seen on the exterior of the PIC 300.

In some instances, the object 301 can be attached to an interior portion of the PIC 300 but can be observed through an aperture 310 in the wall 302 of the PIC 300. The object 301 need not be partially or completely exterior to the aperture 310. In some instances, the object 301 can be completely interior to the aperture 310 but can be observed on the exterior of the PIC 300.

In some instances, an object 301 can be attached to the exterior of the PIC 300 wherein the exterior of the PIC 300 does not include an aperture 310. Instead, the light source projects light through at least a portion of the PIC and through the object 301, e.g., because of the thinness or material of the PIC.

The attachment of a lighting system to a PIC 300 may vary in alternate examples. A lighting system can include several elements including but not limited to a light source 306, a battery pack 309, connecting wires 313, a switch, a dimmer, a circuit board, and/or a power plug connector. If included, each element within the lighting system can be attached separately or be integrated together. Each present element of the lighting system can be directly attached to a wall 302 of the PIC 300 or can be attached directly to a mounting member 305 and the mounting member 305 can be attached to the PIC 300.

The mounting member of the lighting system can be mounted in the same fashion as described in the mounting of the object 301. In some instances, an object 301 can be mounted using a first mounting member and elements of the lighting system can be mounted using a second mounting member. In some instances, an object and all elements of the lighting system can be mounted using the same mounting member. In some instances, an object and some but not all elements of the lighting system can be mounted using the same mounting member.

Additionally, the mounting member 305 for the lighting system can be removably positioned in a pocket 307, 308 secured to an inner surface of the body. The pocket 307, 308 can be a hard casing or could be a softer material. For instance, the pocket 307, 308 can be made of plastic, fabric, metal, or any other material. The pocket 307, 308 can be a permanent part of the interior of the PIC 300 that would involve destruction of part of the PIC to be removed or may be removably attached and thus configured to be removable without damage to any part of the PIC. For instance, the pocket 307, 308 can be sewed onto the interior wall 302 of the body 304 of the PIC 300 or could be within the layers of the wall.

A light source 306 can be attached or removably attached to the PIC 300 in a number of ways. For instance, among other attachment possibilities, a light source 306 can be freely in the bottom of the PIC 300, a light source 306 can be secured to the interior of the PIC 300, a light source 306 can be inserted into a lining of the PIC 300, or a light source 306 can be inserted into a pocket 307, 308 (as described above) attached to or part of the interior of the PIC 300.

In some instances, an element of the lighting system can be attached alongside or connected to the object 301. Accordingly, in a preferred embodiment, a light source 306 can be positioned in such a way as to project light outward and through the object 301. Specifically, the light source 306 can be positioned in the interior space and radially inward of an object 301 and configured to project light outward and through the object 301, for example through the outward face of the object, such that the light source 306 illuminates the object when the light source 306 is illuminated and the light radiates through the object and outward from the PIC.

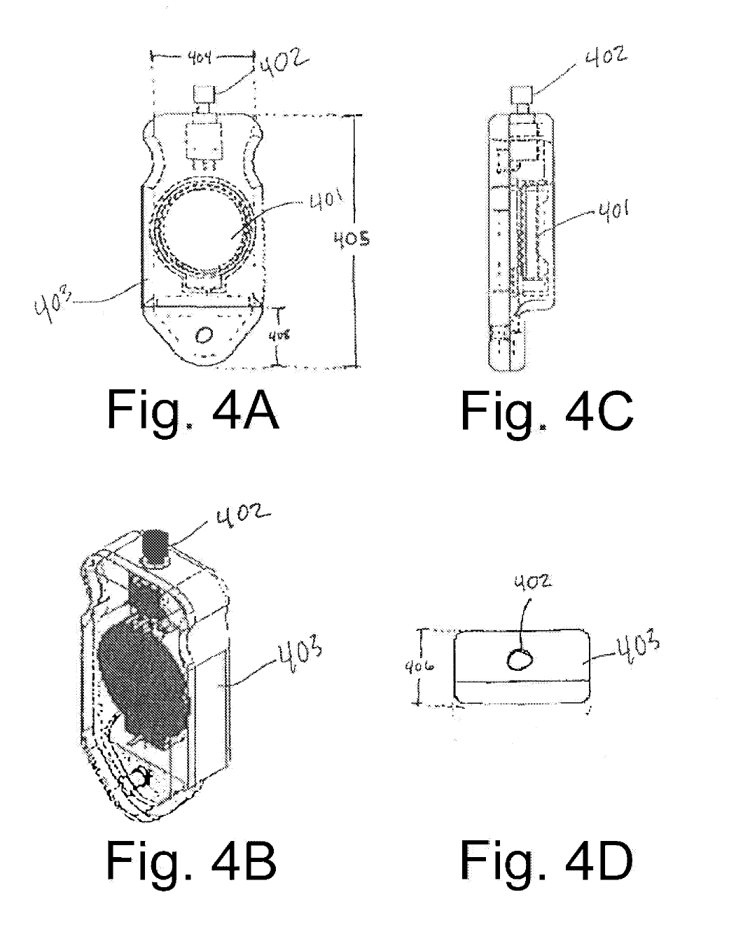

As shown in FIG. 3, the light source 306 and object 301 are mounted together. Yet in other instances, the object 301 can be mounted using the first mounting member (e.g., see FIG. 5) and the light source 306 can be mounted using the second mounting member (e.g., see FIGS. 4A-4D).

In some instances, the object 301 and light source 306 can be attached and removed from a PIC without causing damage to the exterior of the PIC 300.

FIGS. 4A through 4D, collectively FIG. 4, are diagrams illustrating a mounting member 403 and light source 401 according to an implementation of the concepts described herein. FIG. 4A is a front view, FIG. 4B is a back view, FIG. 4C is a side view, and FIG. 4D is a top view of a light source 401 attached to a mounting member 403.

As shown in FIG. 4, the light source 401 can be mounted to a mounting member 403. The mounting member 403 can be generally rectangular in shape, as shown in FIG. 4, or can be any shape in which mounting the light source 401 is feasible.

The size of the mounting member 403 may vary in alternate examples. The length 404 or height 405 of the mounting member can be generally equal to the length and height of the light source 401, or the length 404 or height 405 of the mounting member 403 can be smaller or larger than the length or height of the light source 401. For instance, the height 405 can be less than or equal to about: 6 inches, 4 inches, 3 inches, 2.5 inches, 2 inches, or in a range between any combination of these values as well as possibly outside such ranges. The height 405 of the mounting member 403 can be less than or equal to about 20% of a height of the PIC (or less than or equal to about 15%, 10%, 5% or in a range between any combination of these values as well as possibly outside such ranges). The length 404 can be less than or equal to about: 2 inches, 1.5 inches, 1.25 inches, 1 inch, or in a range between any of these values or otherwise. The length 404 of the mounting member 403 can be less than or equal to about 20% (or less than or equal to about 15%, 10%, 5%) of a height of the PIC or in a range between any of these values or possibly outside such ranges.

Additionally, the width 406 of the mounting member 403 may vary in alternate examples. For instance, the width 406 can be less than or equal to about 1.0 inch, 0.75 inches, 0.65 inches, 0.5 inches, or otherwise. The width 406 of the mounting member 406 can be less than or equal to about 25% (or less than or equal to about 20%, 15%, 10%, 5% or otherwise) of a width of the PIC. The width 406 can depend on, among other things, the size of the light source 401, the positioning of the mounting member 403 on the PIC, the desired flexibility of the mounting member 403, or the like.

In some instances, it will be beneficial for the mounting member 403 to be smaller in size. For example, a smaller mounting member 403 does not increase the weight of the PIC or obstruct the use of the PIC as much as a larger mounting member 403 might. Additionally, a smaller mounting member 403 may be cheaper to manufacture than a larger mounting member 403, but not necessarily so. In contrast, in some instances it will be more beneficial for the mounting member 403 to be larger in size. For instance, a larger mounting member 403 can provide more structural support to the PIC or the object.

Additionally, a power toggle switch or button 402 can be attached to the top of or any portion of the mounting member 403. As similarly described above, the power switch 402 can be configured to toggle the light source (not shown) between an on and off condition. A lower portion 408 of the mounting member 403 (e.g., below the light source 401) can be tapered. A height 408 of the lower portion can be less than about a third or less than about a quarter of a total height 405 of the mounting member 403. The lower portion 408 can be a tab used to mount the mounting member to the PIC.

FIG. 5 illustrates a cross section of one embodiment of an illuminated PIC. The PIC 500 can include a wall portion 502 of the body of the PIC 500 wherein the wall portion 502 can include an exterior layer 507, an interior lining 504, and an aperture 506 through both the exterior layer 507 and the interior lining 504. The PIC 500 further can include a light source mount 505 and an object 501.

The object 501 can be mounted with a plurality of projections 503 configured to extend through at least the exterior layer 507 but in some instances can extend through multiple layers such as the interior lining 504 and possibly any other layer therebetween or between the object and the light source mount 505 and possibly into the light source mount. Each of the projections 503 can include an end portion configured to bend relative to a remaining portion of each projection, such that the projections can engage the wall portion 502 and/or other layers 504 or components such as the light source mount 505. As discussed above, each of the layers 507, 504 can be glued together or attached by other ways such as thread, nails, tacks, etc. Furthermore, the light source mount 505 can be made of plastic.

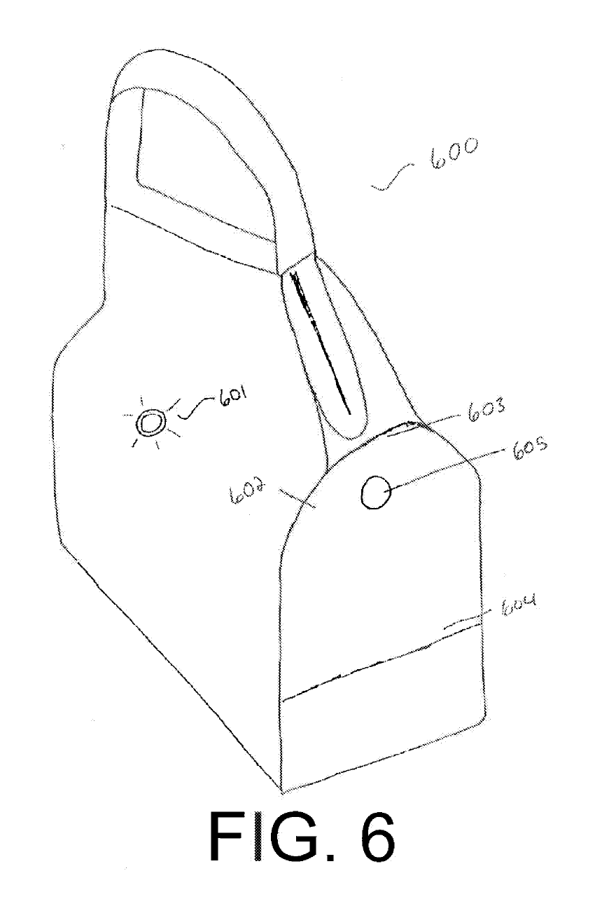

FIGS. 6 through 8 are illustrations of an illuminated PIC further including a compartment capable of being accessible external to the body. A compartment may be utilized in a number of ways including but not limited to holding personal items such as money, jewelry, keys, electronic devices, or makeup or converting into a day-to-day item, such as a portable desk. In some instances, the compartment can be a jewelry box.

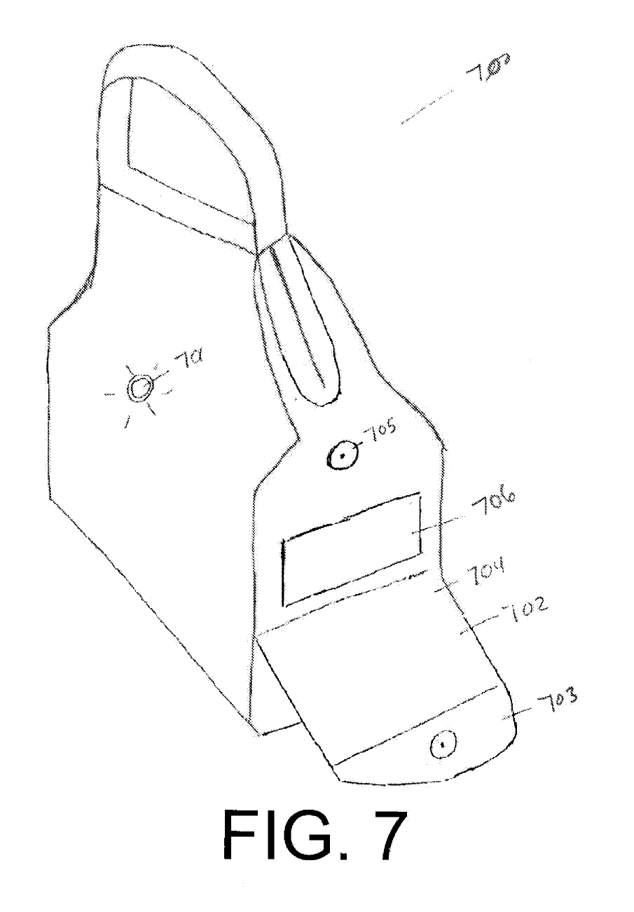

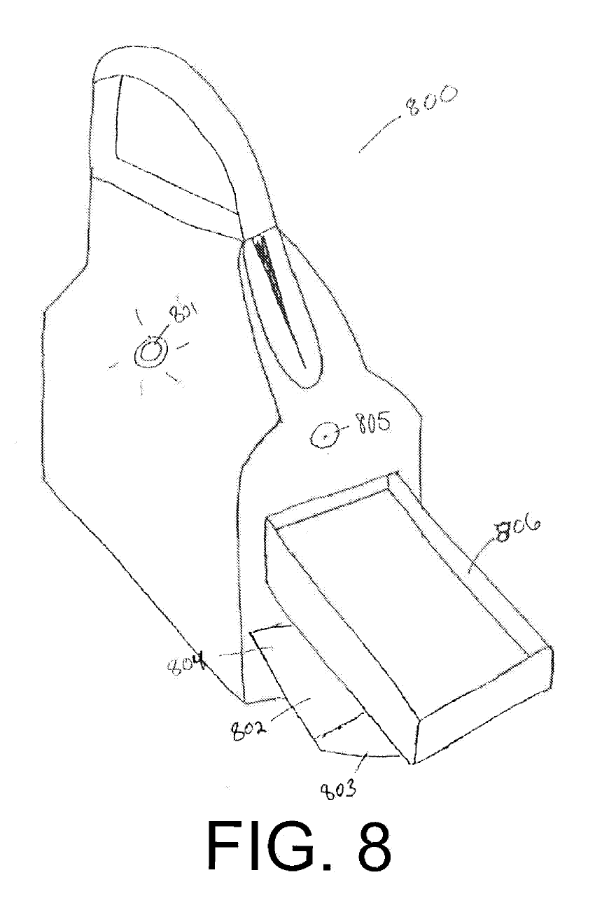

A compartment can be configured to slide outward towards open configuration and slide inward towards the closed configuration. FIGS. 6-7 illustrate some examples of a PIC in closed position, while FIG. 8 illustrates an embodiment of a PIC in open position. In some instances, the compartment can be configured to transition between an open configuration in which contents in the compartment are accessible and a closed configuration in which the contents of the compartment are not accessible.

A PIC can include a flap portion which can be capable of concealing a compartment. The flap portion can include a top end and a bottom end, wherein the bottom end of the flap portion can be attached to the PIC and the top end can be removably connected to the PIC. Although in other configurations, the bottom end or lateral sides of the flap portion can be removably connected to the PIC. In some instances, the top end can be removably connected by a button fastener, a snap fastener, hook and loop fastener, string fastener or the like.

FIG. 6 illustrates embodiment of a PIC 600 having a compartment (not shown) that can be secured within the PIC 600 by a flap portion 602 having a free portion 603 attached to the body of the PIC 600 by a button 605 (or other engagement feature). An anchored portion 604 is fixed to a wall of the PIC 600. Accordingly, the compartment is not accessible external to the body, and thus the PIC 600 is in closed configuration. The PIC 600 can include an illuminated object 601 similar to any illuminated object described herein.

FIG. 7 illustrates the illuminated PIC 700 with an illuminated object 701 similar to any illuminated object described herein. In contrast to FIG. 6, the free portion 703 of the flap portion 702 is detached from the button 705 of the PIC 700 and the outer surface of the compartment 706 is visible from the exterior of the PIC 700. An anchored portion 704 of the flap portion 702 remains attached to the PIC 700. The compartment 706, however, remains inside the PIC 700 and therefore is not accessible external to the body. Thus, FIG. 7 illustrates one example of a PIC 700 in closed configuration.

FIG. 8 illustrates the illuminated PIC 800 with an illuminated object 801 similar to any illuminated object described herein. The illuminated PIC 800 is in open configuration with the free portion 803 of the flap portion 802 unattached from the wall portion of the PIC 800 (e.g., the button 805) and the anchored portion 804 of the flap portion 802 attached to the PIC 800. The compartment 806 has been slid outward wherein the contents of the compartment 806 are accessible. This compartment may comprise for example, a drawer. In certain implementations, the PIC may include a track or rails on which the compartment slides.

The materials of a compartment can vary in alternate examples. A compartment can be made of a relatively hard material such as wood, plastic, metal, or the like. Among other advantages, a relatively hard material can provide added durability to the PIC. A compartment can also be made of relatively soft material such as fabric or other PIC material. Among other advantages, a relatively soft material is typically flexible.

In some instances, a compartment can be completely removable from a PIC. A removable compartment, among one advantages, provides for easier replacement and cleaning. In other instances, a compartment is not capable of being removed. In these examples, most or the compartment can be accessible outside the body of the PIC, but at least an end portion of the compartment is prevented from being removed. Among other advantages, a non-removable compartment prevents a compartment from falling out or getting lost.

The dimensions of the compartment vary between alternate examples. For instance, the compartment can be the same length, width or height as the PIC or can be any size smaller. The compartment may have a width that is, for example, between 95% to 85%, or 85% to 75%, 75% to 55%, 55% to 35%, 35%to 15%, of the width of the PIC. Similarly, the length of the compartment may, for example, be between 95% to 85%, or 85% to 75%, 75% to 55%, 55% to 35%, 35% to 15%, of the length of the PIC. The compartment can be positioned anywhere within the PIC including near the bottom, middle, or top of the PIC. The compartment can be accessed from any area of the PIC, e.g., a front surface, rear surface, lateral surface, or bottom of the PIC. Additionally, the compartment can be any shape. In some instances, the PIC contains multiple compartments.

### Terminology

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The foregoing is illustrative of embodiments and is not to be construed as limited thereof Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concepts as defined in the claims.

Some embodiments have been described in connection with the accompanying drawings. However, it should be understood that the figures are not drawn to scale. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein.

Moreover, while illustrative embodiments have been described herein, the scope of any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to the examples described in the present specification or during the prosecution of the application, which examples are to be construed as non-exclusive. It is intended, therefore, that the specification and examples be considered as illustrative only, with a true scope and spirit being indicated by the claims and their full scope of equivalents.

What is claimed is:

1. A personal item container having an illuminated object on its exterior surface comprising:
a body comprising an exterior wall portion defining an interior space and an opening in a portion of the body through which the interior space can be accessed;
at least one non-opaque object visible on the exterior wall portion; and
a light source positioned inwardly of the at least one non-opaque object and configured to project light outward and through the non-opaque member, such that the light source illuminates the non-opaque object when the light source is illuminated.

2. The personal item container of claim 1 comprising one non-opaque object.

3. The personal item container of claim 1 comprising multiple non-opaque objects.

4. The personal item container of claim 2 wherein said light source is configured to illuminate said at least one non-opaque object with continuous illumination.

5. The personal item container of claim 1 wherein said light source is configured to illuminate said at least one non-opaque object with alternate on-off illumination.

6. The personal item container of claim 3 wherein said light source is configured to illuminate said non-opaque objects sequentially.

7. The personal item container of claim 3 wherein said light source is configured to illuminate said multiple non-opaque objects simultaneously.

8. The personal item container of claim 3 wherein said multiple non-opaque objects are arranged in a pattern having at least one segment having a straight configuration.

9. The personal item container of claim 3 wherein said multiple non-opaque objects are arranged in a pattern having at least one segment having a curved configuration.

10. The personal item container of claim 1 wherein said light source comprises an optical fiber.

11. The personal item container of claim 1 wherein said light source is battery powered.

12. The personal item container of claim 1 which further comprises a switch configured to switch the light source between an on condition and an off condition.

13. The personal item container of claim 12 wherein said switch is configured to be activated and deactivated by a remote controller.

14. The personal item container of claim 1 wherein said light source comprises an LED.

15. The personal item container of claim 1, wherein the at least one non-opaque object is translucent.

16. The personal item container of claim 1, wherein the at least one non-opaque object is transparent.

17. The personal item container of claim 1, wherein the at least one non-opaque object comprises glass.

18. The personal item container of claim 1, wherein the at least one non-opaque object comprises precious stone.

19. The personal item container of claim 1, wherein the at least one non-opaque object comprises a sapphire.

20. The personal item container of claim 1, wherein the at least one non-opaque object comprises a shaving of a stone.

21. The personal item container of claim 1, wherein the at least one non-opaque object comprises a ruby.
